(19) United States
(12) Patent Application Publication
(10) Pub. No.: US 2017/0207664 A1
(43) Pub. Date: Jul. 20, 2017

(54) UNIVERSAL WIRELESS POWER SYSTEM COIL APPARATUS

(71) Applicant: Garrity Pwer Services LLC, Rockwall, TX (US)

(72) Inventor: Paul GARRITY, Rockwall, TX (US)

(73) Assignee: Garrity Power Services LLC, Rockwall, TX (US)

(21) Appl. No.: 15/407,055

(22) Filed: Jan. 16, 2017

Related U.S. Application Data
(60) Provisional application No. 62/280,136, filed on Jan. 19, 2016.

(51) Int. Cl. H02J 50/12; H01F 1/16; H01F 1/20; H01F 1/34; H01F 38/14; H02J 50/60

(52) U.S. Cl. CPC H02J 50/12; H01F 38/14; H02J 50/60; H01F 1/20; H01F 1/34; H01F 1/16

(57) ABSTRACT

A wireless power system. In one embodiment, the wireless power system comprises a wireless transmitter capable of transmitting power and a wireless receiver capable of receiving power such that the coupling between the transmitter and receiver is negligibly affected by introduction of an electrically conducting object near the wireless power system.

### RELATED APPLICATIONS

This patent application claims priority benefit to a provisional patent application titled “Universal Wireless Power System Coil Apparatus” U.S. Application No. 62/280,136, filed Jan. 19, 2016, incorporated by reference herein in its entirety.

### TECHNICAL FIELD

The present invention is directed, in general, to wireless power transmission and, more specifically, to a wireless power system and method of operating the same.

### BACKGROUND

Wireless transmission of power typically performed with a magnetic device such as a transformer has been known in the industry for many decades and first demonstrated by Nicola Tesla over one hundred years ago. Tesla used a very high voltage across a coil or winding to light a lamp several feet away. Wireless power systems disclosed many decades ago suffered from many limitations, foremost of which was very poor coupling between the transmitting and receiving coil of the transformer. In recent years, wireless power systems have been developed that use resonant operation to boost the coupling between transmitting and receiving coils.

The standard modern wireless power system uses two planar coils (also referred to as “windings”), one coil for the power transmitter and one coil for the power receiver. The two most common types of systems currently in use are magnetic induction and magnetic resonance.

Magnetic induction systems operate on a principle similar to a transformer in which two coils (the transmitter and receiver) are coupled together magnetically. The magnetic path benefits from placement of a magnetic material above the receiving coil and another below the transmitting coil (assuming that the receiver sits above the transmitter). The magnetic material above the receiving coil and below the transmitting coil helps to complete a path for magnetic flux to increase the coupling between the two coils. Magnetic inductive systems typically operate at frequencies between 100 kHz and 300 kHz according to wireless power standards Qi and PMA.

Magnetic resonant systems operate by creating two high-frequency resonant tanks formed with a coil and a capacitor, and tuning those resonant tanks to the same frequency. One resonant tank coil acts as a transmitter and another acts as the receiver. Typical operating frequencies for magnetic resonant systems are 6.78 MHz and 13.4 MHz. Magnetic resonant systems can transmit over larger distances and are less sensitive to coil orientations than are magnetic induction systems.

Unlike magnetic induction systems, magnetic resonant systems are intolerant to proximity of standard high permeability magnetic materials such as ferrite since the proximity of such materials tends to shift the resonant frequency of the transmitter or receiver, thus detuning the system and causing substantial interference in the transfer of power. Magnetic resonant systems are also sensitive to the proximity of magnetic conductors. So, for example, if a magnetic resonant transmitter is placed onto a metal surface, the metal surface could cause the system resonant frequency to shift away from the operating frequency and destroy the effective power transfer. Designers of magnetic resonant systems must take this limitation into account when designing transmitters to either design the transmitter into a piece of furniture without any metallic backing, or to place the transmitter on a non-metallic platform high enough to avoid sensitivity to a metallic surface on which the platform is placed. Despite some of the advantages of magnetic resonant systems regarding lower sensitivity to coil orientations and transmitting distance, the limitation of proximity to metallic surfaces renders the magnetic resonant transmitter less adaptable to various applications and higher cost in many other applications. Additionally, the high-frequency operation of magnetic resonant systems coupled to their sensitivity to nearby conductors or magnetic material can create additional problems with electromagnetic interference for nearby devices.

Due to the concurrent development of several wireless standards that include both magnetic induction and magnetic resonance, the wireless power industry is attempting to produce transmitters that work across multiple standards. One of several obstacles in this development is the conflict between boosting magnetic induction coupling through addition of ferrite (or other high-permeability magnetic material) core material around the transmitter coils, and the need to keep high-permeability magnetic material away from magnetic resonance systems.

### SUMMARY OF THE INVENTION

These and other problems are generally solved or circumvented, and technical advantages are generally achieved, by advantageous embodiments of the present invention, including a wireless power system which can operate via magnetic resonance without limitations of placement near metallic surfaces and a wireless power system which can operate efficiently in both magnetic induction and magnetic resonance modes. Embodiments of the present invention also include methods of operating and forming the same. In one embodiment, the wireless power system comprises a wireless power transmitter that comprises a first coil capable of transmitting power, and a wireless power receiver that comprises a second coil capable of receiving power, the first coil and second coil being configured to form a first electro-magnetic coupling at a first operating frequency. The wireless power transmitter or the wireless power receiver further comprises a limited flux steering mechanism capable of reducing the effect of nearby conductive objects on the first electromagnetic coupling.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 is a perspective view of a magnetic resonance wireless power transmission coil apparatus constructed in accordance with an embodiment of the invention;

FIG. 2 is a perspective view of coil apparatuses of a magnetic resonance wireless power transmitter and receiver constructed in accordance with another embodiment of the invention;

FIG. 3 is a perspective view of coil apparatuses of a magnetic induction wireless power transmitter and receiver system constructed in accordance with another embodiment of the invention; and

FIG. 4 is a perspective view of a universal transmission coil apparatus constructed in accordance with another embodiment of the invention.

Corresponding numerals and symbols in the different FIGUREs generally refer to corresponding parts unless otherwise indicated, and may not be re-described in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a wireless power system, and methods of operating and forming the same. While the principles of the present invention will be described in the environment of a wireless power system, any application that may benefit from wireless transfer of power is well within the broad scope of the present invention. Additionally, while the principles of the present invention will be described with respect to electronic devices (also referred to as a “load”) such as cell phones, tablets, and power tools, other applications such as motor controllers and amplifiers are well within the broad scope of the present invention.

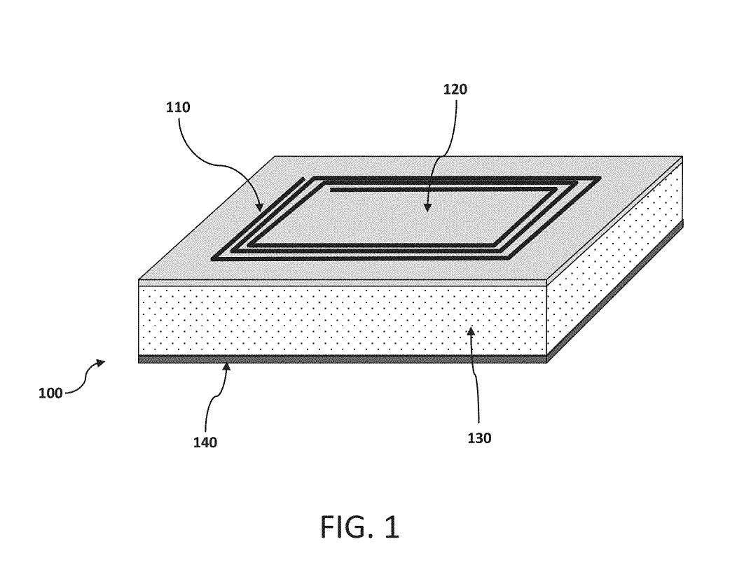

Turning now to FIG. 1, illustrated is an embodiment of a transmitting coil apparatus for a wireless power system that operates with magnetic resonant coupling. Transmitting coil apparatus 100 comprises printed circuit board 120 which contains planar coil 110. Material 130 is a limited flux steering material composed of low-permeability magnetic material. Material 130 is located under circuit board 120. A sheet of conductive material 140 is located under flux steering material 130.

Whereas prior art magnetic resonant transmission coils use no magnetic material and cannot be located near a sheet of conductive material, the embodiment shown in FIG. 1 shows both a magnetic material 130 and a sheet of conductive material 140.

There are several reasons that prior art magnetic resonant transmission coils use no magnetic material.
1. Magnetic resonant systems operate at very high frequencies (typically 6.78 MHz or 13.4 MHz) and the addition of a standard high-flux magnetic material would contribute significant losses.
2. Standard high-flux material substantially increases the inductance of the coil and causes the system resonance to vary with relative locations of transmitting and receiving coils. Since both transmitter and receiver in resonant systems must be accurately tuned to the same frequency, the system cannot tolerate variations in resonant frequency.
3. It is difficult to obtain optimal characteristic impedance of the transmitter and receiver if the transmitter coil has a high inductance.

The embodiment shown in FIG. 1 uses a limited flux-steering material 130 rather than a high-flux magnetic material. Flux-steering material 130 will typically have a relative permeability between 2 and 25 (as opposed to a standard high-flux material that has a relative permeability on the order of 10,000). The limited flux-steering material 130 helps to steer only some of the flux that comes down through coil 110 back up through printed circuit board 120 with only minimal effect on inductance, whereas a high-flux material would guide nearly all (greater than 99%) of the flux back up and would also increase the inductance of the coil substantially. Limited flux-steering can be accomplished using a powdered iron core that has a very low density of iron, though other alternatives can be used as well. The low density of magnetic material in the flux-steering material produces very low loss, even at the typically high frequencies used for magnetic resonant wireless transmission.

Flux-steering material 130 is made thick enough to steer much of the flux through coil 110 back up through printed circuit board 120; however, due to the very low permeability of flux-steering material 130, only some of the flux is steered back up through the circuit board while some of the magnetic field also penetrates through limited flux-steering material 130. Conductive sheet 140 creates eddy currents to oppose the stray fields passing through flux-steering material 130 and thus prevents any magnetic field from passing down through transmitting coil apparatus 100. Since much of the magnetic flux passing down through flux-steering material 130 is steered back up, the net losses due to conductive material 140 are relatively low.

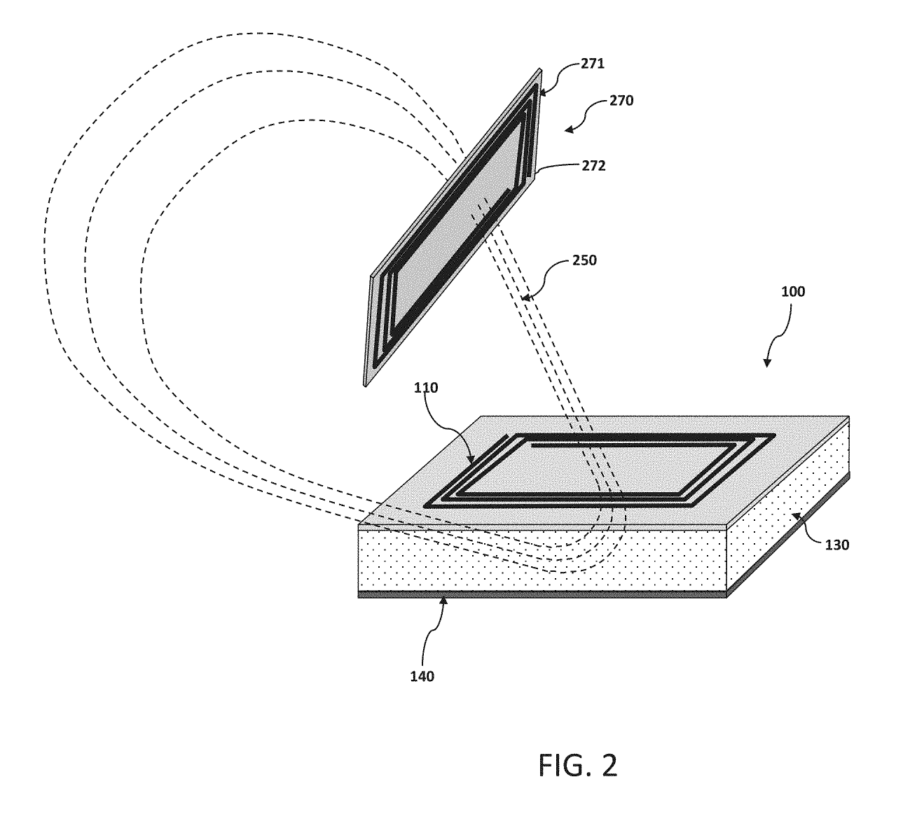

Turning now to FIG. 2, illustrated is the transmitting coil apparatus of FIG. 1 as well as receiving coil apparatus 270. Receiving coil apparatus 270 comprises printed circuit board 272 with planar winding 271. Coils 110 and 271 are coupled by magnetic field lines 250. Magnetic resonant wireless transmission allows power transmission over a large range of coil orientations such as the non-parallel orientation of the coil 271 with respect to coil 110 as shown in FIG. 2. As illustrated, magnetic field lines 250 are steered upward by flux-steering material 130. If flux-steering material 130 had not been present, magnetic field lines 250 would have instead gone downward a much greater distance before gradually turning upward. Thus the combination of flux-steering material 130 and conductive sheet 140 prevents flux from passing down past transmitting coil apparatus 100 thus desensitizing the wireless transmitter to effects of conductive objects placed below the transmitter.

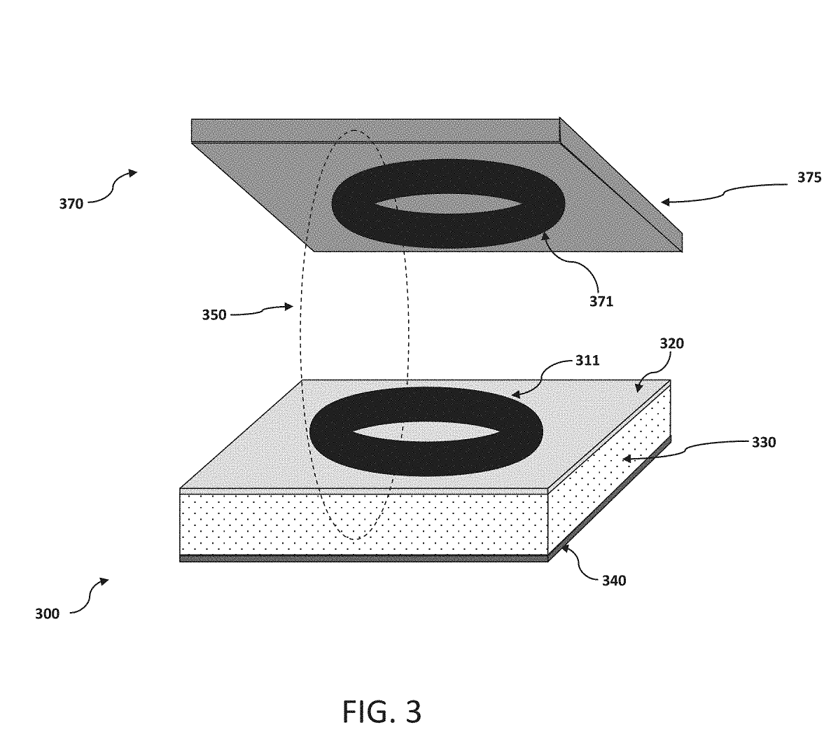

Turning now to FIG. 3, illustrated is a transmitting coil apparatus 300 and a receiving coil apparatus 370 for a magnetic induction wireless power system. Transmitting coil apparatus 300 comprises printed circuit board 320 which contains Litz-wire coil 311. The circuit board 320 allows control or power circuitry to be placed near the coil 311. Material 330 is a sheet of limited flux steering material located under circuit board 320. Material 330 is composed of low-permeability magnetic material similar to that described for material 130 in FIGS. 1 and 2. A sheet of conductive material 340 is located under flux steering material 330. Receiving coil apparatus 370 comprises high-permeability ferrite 375 and Litz-wire coil 371. Coils 311 and 371 are coupled by magnetic field 350.

Limited flux steering material 330 has a relative permeability between 2 and 20 and typically comprises powdered iron. Flux steering material 330 helps to magnetically couple coils 311 and 371 to each other. While a high-permeability material would provide better magnetic coupling than a low-permeability material, the low-permeability material still provides adequate coupling. Conductive sheet 340 prevents stray magnetic fields from penetrating below coil apparatus 300 and thus reduces electromagnetic interference. The fact that the low-permeability material 330 enables adequate coil coupling allows the creation of a universal wireless power coil.

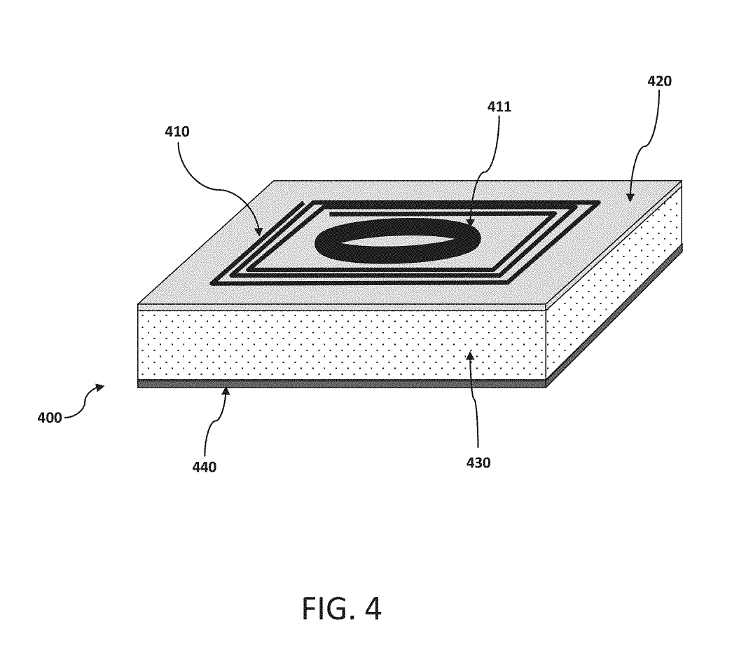

FIG. 4 illustrates an embodiment of a universal wireless power coil apparatus 400. Printed circuit board 420 contains planar coil 410 that can be used for transmitting power to resonant wireless power receivers. Litz-wire coil 411 is mounted on top of printed circuit board 420 and can be used for transmitting power to inductive wireless power receivers. Low-permeability iron powder sheet 430 provides the ability to steer flux in both resonant and inductive wireless power modes. Conductive sheet 440 prevents magnetic fields from passing through wireless power coil apparatus 400, thus lowering electromagnetic interference and desensitizing the transmitter to effects from proximity to electrically conductive material located underneath transmitting coil apparatus 400.

The wireless power coil apparatus 400 illustrated in FIG. 4 is a combination of wireless coil apparatus 100 illustrated in FIG. 2 and wireless coil apparatus 300 illustrated in FIG. 3. It should be readily understood that the operation in either magnetic resonant mode using coil 410 or that operation in magnetic inductive mode using coil 411 is the same as previously described for wireless coil apparatus 100 and wireless coil apparatus 300 in magnetic resonant and magnetic inductive modes respectively. The wireless power coil apparatus 400 may operate broadly over a frequency range extending between approximately 20 kHz and approximately 20 MHz. In some embodiments, the wireless power coil apparatus 400 may operate over two distinct frequency ranges. More particularly, the wireless coil apparatus 400 may operate according to both Qi (or PMA) wireless standards and A4WP wireless standards. Qi (or PMA) transmissions may be conducted between approximately 80 kHz and 300 kHz, and more specifically between approximately 110 kHz to 205 kHz. A4WP transmissions may be conducted at approximately 6.78 MHz.

Wireless power coil apparatus 400 is thus able to operate in either magnetic resonant mode or magnetic inductive mode, thereby representing a universal wireless power coil apparatus. Furthermore, wireless power coil apparatus 400 desensitizes the transmitter to effects from proximity to electrically conductive material located underneath the transmitter and also reduces electromagnetic interference.

Thus, an improved wireless power system has been introduced that provides cost and performance advantages by using a universal coil backing material that is applicable to use in both magnetic induction and magnetic resonance systems and which eliminates susceptibility of the magnetic resonant transmitter to metallic objects underneath the transmitter. In one embodiment, a wireless power transmitter (100 in FIGS. 1,2) comprises a first coil (110 in FIGS. 1,2 and 410 in FIG. 4) capable of transmitting power, a wireless power receiver (270 in FIG. 2) that comprises a second coil (271 in FIG. 2) capable of receiving power, a first operating frequency, and a first electromagnetic coupling (250 in FIG. 2) between the first coil and the second coil at the first operating frequency. The wireless power transmitter or the wireless power receiver further comprises a limited flux steering mechanism (130 in FIGS. 1,2 and 430 in FIG. 4) capable of reducing the effect of nearby conductive objects on the first electromagnetic coupling.

In a further embodiment, the wireless power transmitter further comprises a third coil (311 in FIGS. 3 and 411 in FIG. 4), a second electromagnetic coupling (350 in FIG. 3) between the first coil and the third coil designed to operate at a second operating frequency such that the limited flux steering mechanism is capable of reducing the effect of nearby conductive objects on the second electromagnetic coupling.

Other effective alternatives will occur to a person skilled in the art. Those skilled in the art should understand that the previously described embodiments of the wireless power system and related methods of operating the same are submitted for illustrative purposes only.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof. Furthermore, a limited flux steering mechanism composed of powered iron allows operation in magnetic resonance mode to frequencies of at least 20 MHz and operation in magnetic induction mode at frequencies down as low as 20 kHz and should not be seen to be limited to the example frequencies already cited. As another example, the same principles discussed for the wireless transmitter apply equally well if implemented instead in the wireless receiver.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A wireless power system comprising:
a wireless power transmitter comprising a first coil configured to transmit power; and
a wireless power receiver comprising a second coil configured to receive power,
one of the wireless power transmitter and the wireless power receiver further comprising a limited flux steering mechanism,
the first coil and second coil being configured to form a first electro-magnetic coupling at a first operating frequency, the limited flux steering mechanism being configured to reduce an effect of nearby conductive objects on the first electromagnetic coupling.

2. The wireless power system of claim 1, the first coil or the second coil being oriented along a plane, wherein the limited flux steering mechanism comprises a sheet of low permeability magnetic material oriented in a plane adjacent to the plane of the first coil or the second coil.

3. The wireless power system of claim 1, wherein the low permeability magnetic material comprises powdered iron.

4. The wireless power system of claim 1, wherein the low permeability magnetic material comprises ferrite.

5. The wireless power system of claim 1, wherein the low permeability magnetic material has a relative permeability between 2 and 25.

6. The wireless power system of claim 1, wherein the power transmitter further comprises a third coil, the first coil and second coil being configured to form a second electromagnetic coupling at a second operating frequency, the limited flux steering mechanism being further configured to reduce the effect of nearby conductive objects on the second electromagnetic coupling.

7. The wireless power system of claim 6, wherein the first coil and the third coil are aligned in a single plane.

8. The wireless power system of claim 7, wherein the limited flux steering mechanism comprises a sheet of low permeability magnetic material oriented in a plane adjacent to the plane of the first coil and the third coil.

9. The wireless power system of claim 8, wherein the low permeability magnetic material has a relative permeability between 2 and 25.

10. The wireless power system of claim 6, wherein the transmitter is configured to operate over a frequency range between approximately 20 kHz to approximately 20 MHz.

11. The wireless power system of claim 6, wherein the ratio of the first operating frequency to the second operating frequency is greater than 30.

12. The wireless power system of claim 11, wherein the first operating frequency is greater than or equal to 6.78 MHz.

13. The wireless power system of claim 2, further comprising an electrically conductive material positioned on one side of the low permeability magnetic material such that the low permeability magnetic material is sandwiched between the electrically conductive material and either the first coil or the second coil.

14. A wireless power transmission system comprising:
a wireless transmitter comprising a first coil and a magnetic structure backing the first coil, the wireless transmitter being configured to wirelessly transmit power at a first frequency below 300 kHz and a second frequency above 3 MHz; and
a wireless receiver configured to receive power.

15. The wireless power transmission system of claim 14, wherein the second frequency is 6. 78 MHz.

16. The wireless power transmission system of claim 14, wherein the first frequency is between 100 kHz and 205 kHz.

17. The wireless power transmission system of claim 14, wherein the magnetic structure comprises a low permeability magnetic material.

18. The wireless power transmission system of claim 17, wherein the low permeability magnetic material comprises iron powder.

19. The wireless power transmission system of claim 17, wherein the permeability of the magnetic material is less than 25.

20. The wireless power transmission system of claim 14, further comprising a layer of high electrical conductivity material.
